(19) United States
(12) Patent Application Publication
(10) Pub. No.: US 2015/0014434 A1
(43) Pub. Date: Jan. 15, 2015

(54) ULTRASONIC SPRAYING DEVICE / AIR-ASSISTED ULTRASONIC SPRAYING DEVICE WITH ADVANCING CARTRIDGE PISTON

(71) Applicant: TEMPTU, INC., New York, NY (US)

(72) Inventor: Gennadi Fedorov, Blairstown, NJ (US)

(73) Assignee: TEMPTU, INC., New York, NY (US)

(21) Appl. No.: 14/188,472

(22) Filed: Feb. 24, 2014

Related U.S. Application Data
(63) Continuation of application No. PCT/US2012/052172, filed on Aug. 23, 2012.
(60) Provisional application No. 61/526,619, filed on Aug. 23, 2011.

(51) Int. Cl. B05B 17/06; A45D 34/00

(52) U.S. Cl. CPC B05B 17/0615; A45D 34/00
USPC 239/102.2

(57) ABSTRACT

The invention provides systems and methods for delivering a fluid, which may be a cosmetic fluid. The fluid delivery system may employ ultrasonic energy to deliver fluid contained in a cartridge using a spraying device. The fluid delivery system may be modular.

### CROSS-REFERENCE

This application is a continuation of PCT/US2012/052172, filed Aug. 23, 2012, which claims the benefit of U.S. Provisional Patent Application Ser. No. 61/526,619, filed Aug. 23, 2011, each of which is entirely incorporated herein by reference.

### SUMMARY OF INVENTION

The invention provides systems and methods for delivering a fluid, such as a cosmetic fluid, using ultrasonic energy. Various aspects of the invention described herein may be applied to any of the particular applications set forth below or for other types of high accuracy or wide coverage fluid delivery applications. It shall be understood that different aspects of the invention can be appreciated individually, collectively, or in combination with each other.

One aspect of the invention provides an apparatus, such as a spraying device with a cartridge containing a fluid.

Another aspect of the invention provides methods of delivering said fluid utilizing ultrasonic energy, including various means to advance said fluid toward the front of said cartridge.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A shows a side view of an outer body of an ultrasonic spraying device in accordance with a preferable embodiment of the present invention.

FIG. 1B shows a top view of an outer body of an ultrasonic spraying device.

FIG. 1C shows a front view of an outer body of an ultrasonic spraying device.

FIG. 2 shows a cut-away side perspective view of an ultrasonic spraying device in accordance with one embodiment of the present invention.

FIG. 3 shows a perspective detail view of a gear assembly.

FIG. 4A shows a side view of a gear-driven cartridge assembly.

FIG. 4B illustrates a section normal to the axis of rotation of a threaded rod in a gear-driven cartridge assembly.

FIG. 4C shows a perspective view of a section normal to the axis of rotation of a threaded rod in a gear-driven cartridge assembly.

FIG. 5A shows a front perspective view of an auto-propelled cartridge assembly.

FIG. 5B shows a back perspective view of an auto-propelled cartridge assembly.

FIG. 6 shows a front perspective view of an auto-propelled cartridge assembly with a nozzle cover removed.

FIG. 7A shows a side view of an auto-propelled cartridge assembly.

FIG. 7B illustrates a section normal to the centerline of an auto-propelled cartridge assembly.

FIG. 7C shows a perspective view of a section normal to the centerline of an auto-propelled cartridge assembly.

FIG. 8 shows a conceptual view of an ultrasonic spraying device in accordance with a gear-driven embodiment.

FIG. 9 shows a conceptual view of an ultrasonic spraying device in accordance with an auto-propelled embodiment.

### DETAILED DESCRIPTION OF INVENTION

The present invention provides systems and methods for delivering fluids using ultrasonic energy. Such fluid dispensing may be used in any application, including, but not limited to cosmetic applications.

One aspect of the invention provides an apparatus, such as a spraying device with a cartridge. The apparatus may be a compact, portable, hand-held, battery-operated device for spraying fluids supplied in the cartridge, utilizing the effect of ultrasonic dispersion and vaporization of fluids assisted by directional air flow.

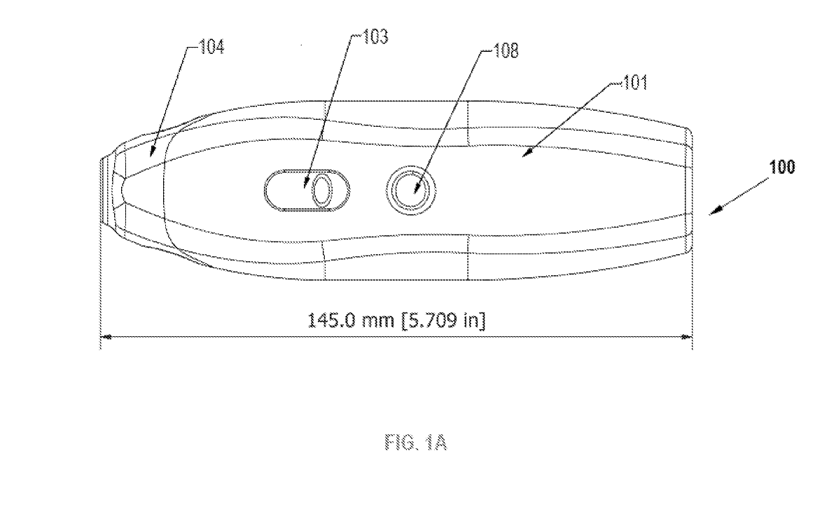

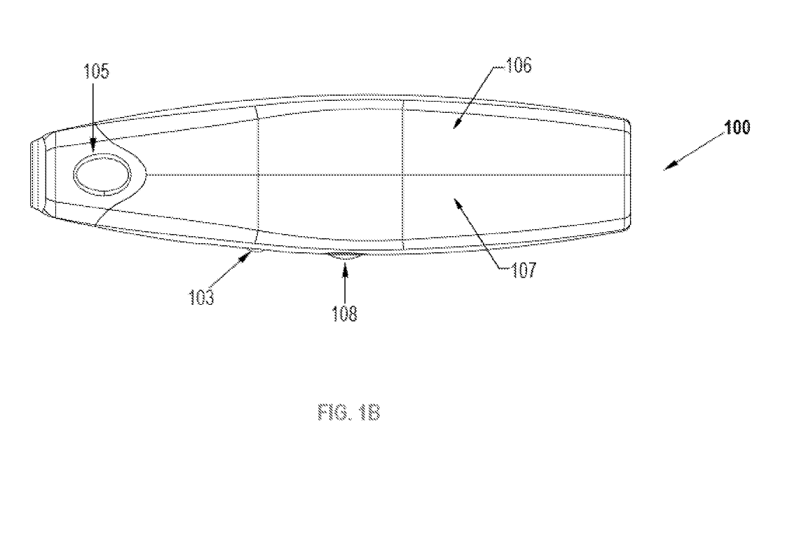

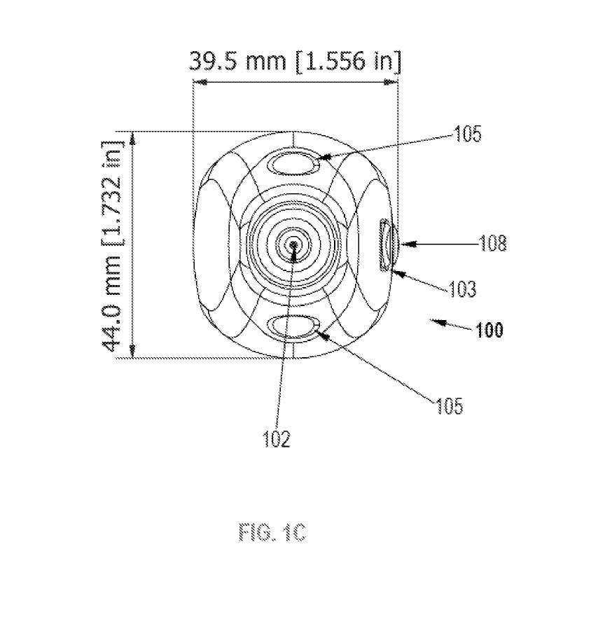

FIG. 1A shows a side view of an outer body of an ultrasonic spraying device in accordance with a preferable embodiment of the invention. The spraying device 100 may have one or more of a device body 101, an on/off power button 108, a slider button controlling the intensity of spray 103, and a front end snap-cover 104. In some arrangements, the on/off power button 108 and the slider button 103 may be located elsewhere on the device body 101. Moreover, both functions may be incorporated into a single button, and a button locking mechanism or other means may be provided.

FIG. 1B shows a top view of an outer body of an ultrasonic spraying device. The spraying device 100 may have a surface feature 105, an on/off power button 108 and a slider button controlling the intensity of spray 103. The surface feature 105 may optionally be an additional button or have additional functionality. The device may be formed of a single integral piece or of multiple pieces and may be sized to fit conveniently in the hand of a user. In one example, the device body 101 is made up of a right body shell 106 and a left body shell 107.

A front view of an outer body of an ultrasonic spraying device, looking into the spray, is shown in FIG. 1C. A nozzle tip 102 may be located in the center of the front face of the device. A possible arrangement of buttons 108 and 103 and a surface feature 105 with respect to the nozzle tip 102 is also shown.

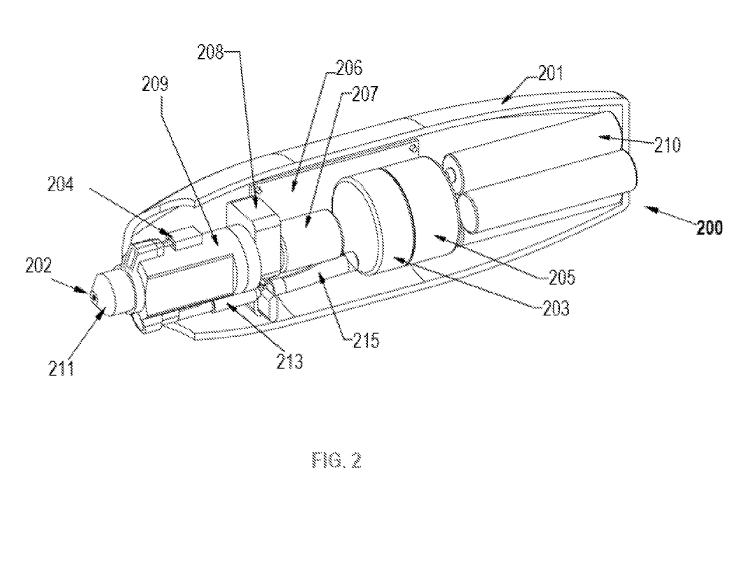

The inside of an ultrasonic spraying device in accordance with one embodiment of the invention is shown in FIG. 2. A spraying device 200 may act as a permanent device handle, base or terminal into which a cartridge 209 can be docked such that a nozzle cover 211 with a nozzle tip 202 protrudes from the spraying device 200. The whole hand-held system may be powered by an internal or external power source. An internal power source may include any primary or secondary electrochemical or other energy storage device, such as a battery, a capacitor, a flywheel or any variation, combination or specific incarnation thereof. In one example, two to four rechargeable Li-ion battery cells 210 may be included. Each battery cell may provide up to 3.7 V of DC voltage and up to 2200 MAh of DC current.

A small motor 205 and a small air pump 203 may provide air flow to an air tube 215 connected to an air coupling tube 213 on the cartridge 209. The air pump 203 may optionally be a small low velocity electric DC air pump. An electric connector 204 may provide electrical connection between the cartridge 209 and the power circuit of the spraying device 200. In some embodiments, a micro electric DC motor 207 and a micro reduction gearbox 208 may be connected to the cartridge 209. The power source 210 may supply power to components 205, 207 and 209 via a PCB controller board 206 connected to user controls on the outside of the device. Further, the relative location of internal components may be varied. For example, the small motor 205 and the small low velocity electric DC air pump 203 may be located behind the power source 210.

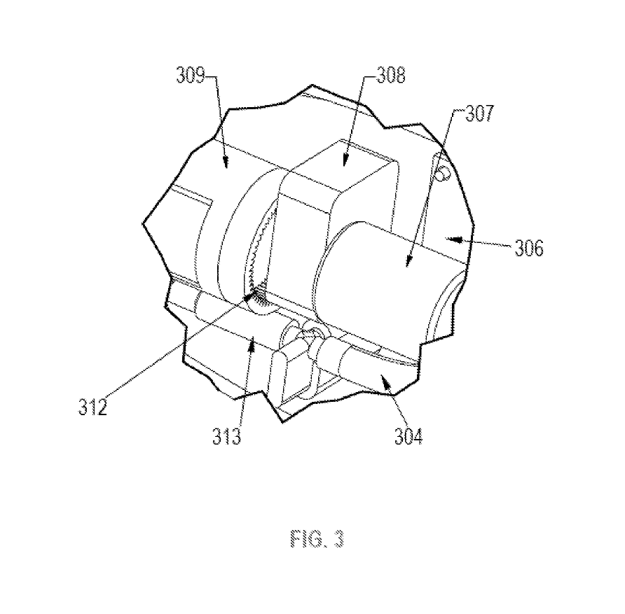

FIG. 3 shows a perspective detail view of a possible gear assembly. A micro electric DC motor 307 and a micro reduction gearbox 308 may be coupled to gear teeth 312 on the back wall of a cartridge 309. The micro electric DC motor 307, coupled with the micro reduction gearbox 308, may allow for a very slow gear motion.

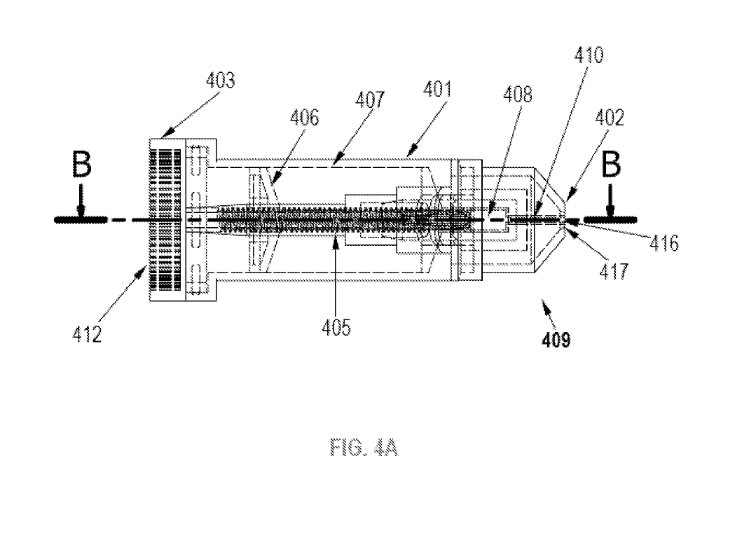

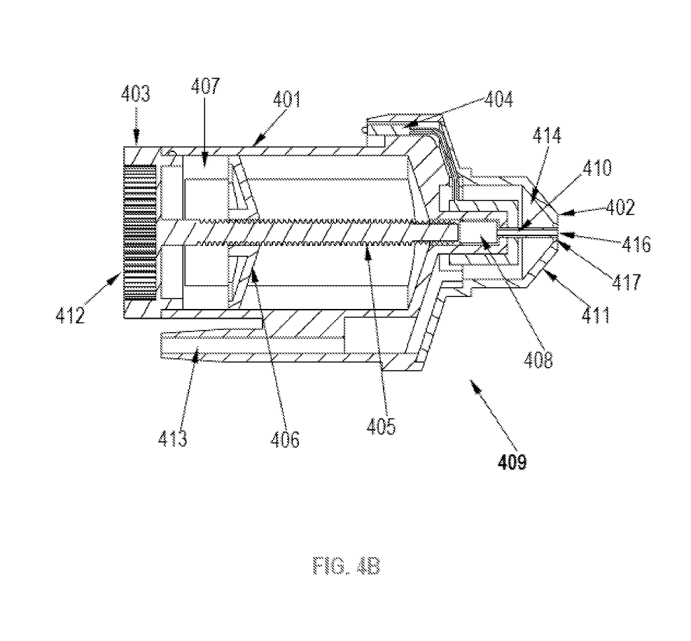

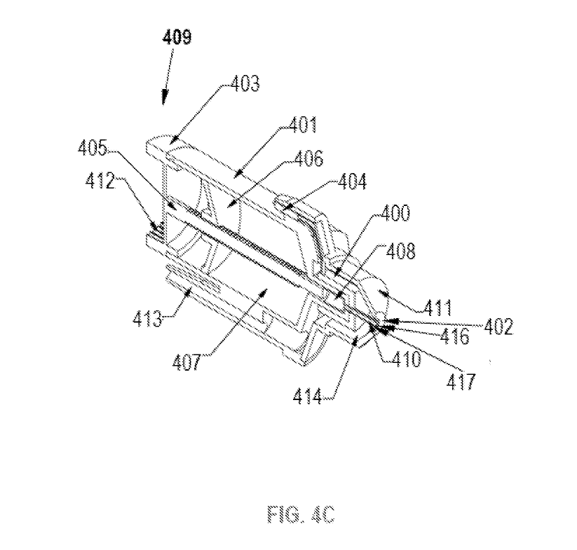

Referring to FIG. 4A, the embodiment illustrated herein is an example of a gear-driven cartridge assembly 409. The rear end of a cartridge body 401 may be plugged by a geared rear wheel 403 with gear teeth 412. Inside a cartridge tank 407 holding fluid, the geared rear wheel 403 may extend as a threaded rod 405, translating a pushing piston 406 forward. The front end of the cartridge tank 407 may lead into a steel front chamber 408, followed by a micro tube 410 exiting at a nozzle tip 402 through a fluid nozzle 416 surrounded by an air nozzle 417.

FIG. 4B shows a section normal to the axis of rotation of a threaded rod 405 of a gear-driven cartridge assembly 409. A geared rear wheel 403 with gear teeth 412 may extend as a threaded rod 405 driving a pushing piston 406 forward inside a cartridge tank 407 enclosed in a cartridge body 401. A steel front chamber 408 and a micro tube 410 may be located inside a nozzle cover 411. Fluid may be dispensed at a nozzle tip 402 by a fluid nozzle 416. An electric connector 404 and an air coupling tube 413 may be located outside the cartridge tank 407 and may be connected to the front portion of the cartridge 409. Air flow may be provided to an air nozzle 417 at the nozzle tip 402 via an air coupling tube 413 and a nozzle air cavity 414.

In a perspective view of a section normal to the axis of rotation of a threaded rod of a gear-driven cartridge assembly 409, shown in FIG. 4C, when a gear drive (not shown) engages gear teeth 412, a geared rear wheel 403 and a threaded rod 405 turn. The threaded rod 405 acts as a lead screw for advancing a pushing piston 406 forward, thereby pushing fluid toward the front of a cartridge tank 407 inside a cartridge body 401. Slowly advancing fluid may enter the front of the cartridge tank 407 and into a steel front chamber 408 surrounded by a tubular piezo-ceramic ultrasonic transducer 400. Fluid may be transferred from the steel front chamber 408 to a fluid nozzle 416 at a nozzle tip 402 via a micro tube 410 at the end of the steel front chamber 408. The tubular piezo-ceramic ultrasonic transducer 400 may transfer ultrasonic high frequency vibrations to said steel front chamber 408 and said micro tube 410, affecting vaporization of fluid exiting the micro tube 410. To guide and shape evaporated fluid into a desired shape and direction, low velocity air may be delivered to the front section of the cartridge via an air coupling tube 413 and a nozzle air cavity 414. Said compressed air may escape at the front end through an air nozzle 417, formed by a small circular gap around the steel tube forming the fluid nozzle 416. A physical or wireless electric connector 404 may provide an electrical connection, such as to a spraying device. The piezo-ceramic ultrasonic transducer 400, steel front chamber 408, micro tube 410 and nozzle air cavity 414 may be housed inside a nozzle cover 411 on the cartridge assembly 409.

In another embodiment, said gear-driven means may be substituted by another form of mechanical propelling, such as an air pneumatic means. The gear-driven means serves as a particular illustration of a forced propelling means, in contrast to an auto-propelled means.

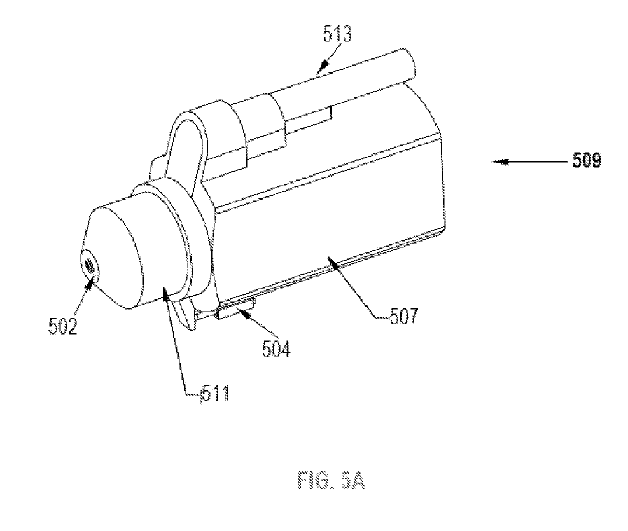

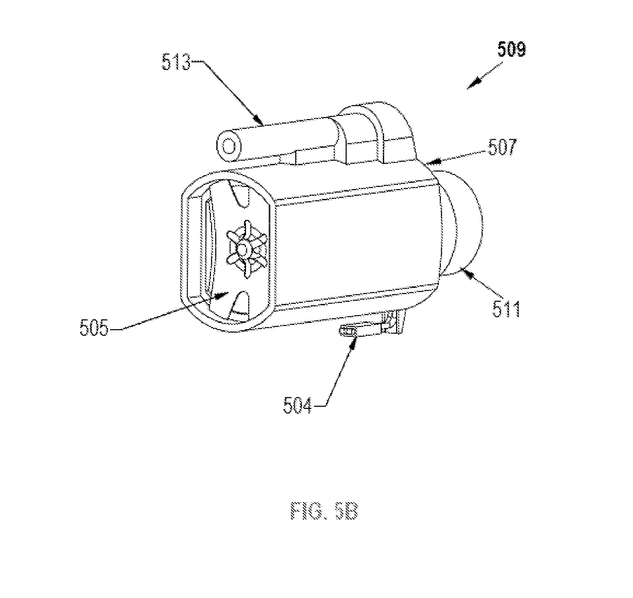

Referring to FIG. 5A, the embodiment illustrated herein is an example of an auto-propelled cartridge assembly 509. This arrangement does not require a motor and a gearbox to propel fluid. An air coupling tube 513 and an electric connector 504 may provide air and electric conduits to the cartridge, such as between a spraying device and the cartridge. A nozzle cover 511 with nozzle tip 502 may be located at the front end of a cartridge tank 507.

FIG. 5B shows a back perspective view of an auto-propelled cartridge assembly 509. The rear end of a cartridge tank 507 holding fluid may be plugged by a steel breaking plate 505. A possible arrangement of the connecting ends of an air coupling tube 513 and an electric connector 504 with respect to a nozzle cover 511 is also illustrated.

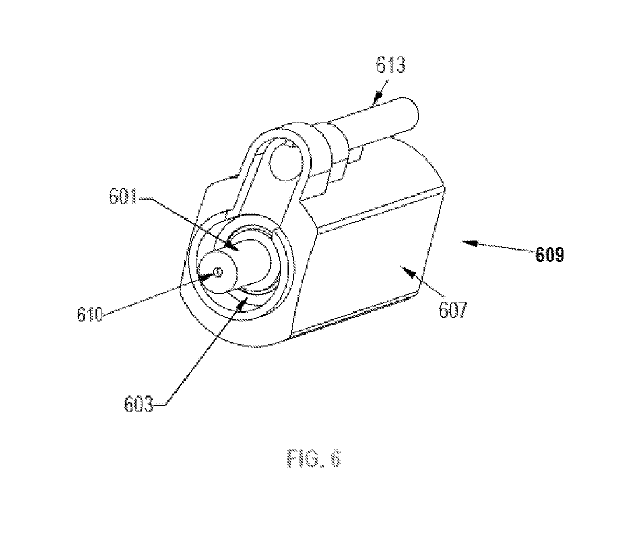

FIG. 6 shows a front perspective view of an auto-propelled cartridge assembly 609 inside a nozzle cover (not shown). A flexing front wall 603 of a cartridge tank 607 may be located right behind a neck 601 containing a micro tube 610. An air coupling tube 613 may be attached to the cartridge tank 607. A tubular piezo-ceramic ultrasonic transducer (not shown) may sit upon the neck 601. In one example, the flexing front wall 603 may be made as a series of concentric ripples with wall thickness smaller than the overall wall thickness of the cartridge tank 607, giving the wall flexibility to vibrate back and forth when activated by the micro vibrations of the ultrasonic transducer. Alternative designs allowing for flexibility of the front wall 603 can be used, such as a flexible membrane.

During micro movement of the flexing front wall 603 toward the rear of the cartridge, the front wall 603 may push onto fluid inside the cartridge tank 607, squeezing this fluid and causing it to look for a possible outlet, provided by said front nozzle tip 502. During micro movement of the flexing front wall 603 toward the front of the cartridge, the front wall 603 may pull the fluid inside the cartridge tank 607 with it as a result of the inability of liquid fluids to be mechanically stretched. Movement of the fluid inside the cartridge tank 607 may be limited to forward movement by utilizing said steel breaking plate 505 that may be installed in the rear of a pushing piston analogous to the embodiment illustrated in FIGS. 4A, 4B and 4C. The steel breaking plate 505 may slide forward in a smooth fashion and drags its spring-loaded prongs along the inside wall of the cartridge tank 607 as it moves. Backward motion of the steel breaking plate 505 is disabled by said prongs. The steel breaking plate 505 acts as a breaking device, preventing the pushing piston (not shown) from moving backward under micro pressure from backward vibrations of the flexing front wall 603, while auto-propelling the content inside the cartridge tank 607 during forward vibrations.

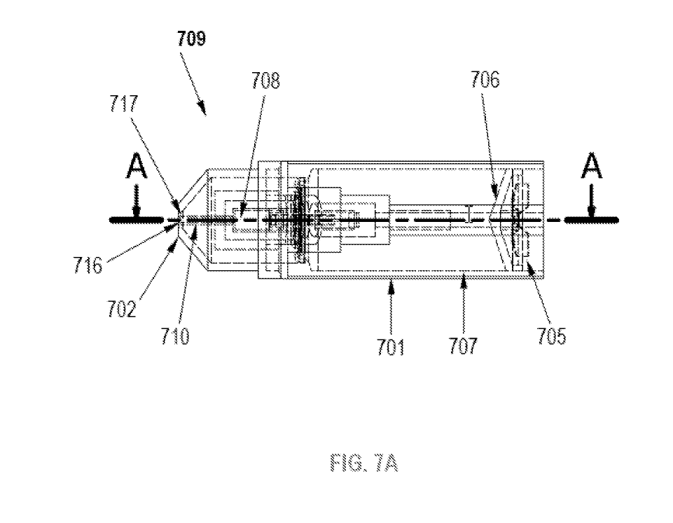

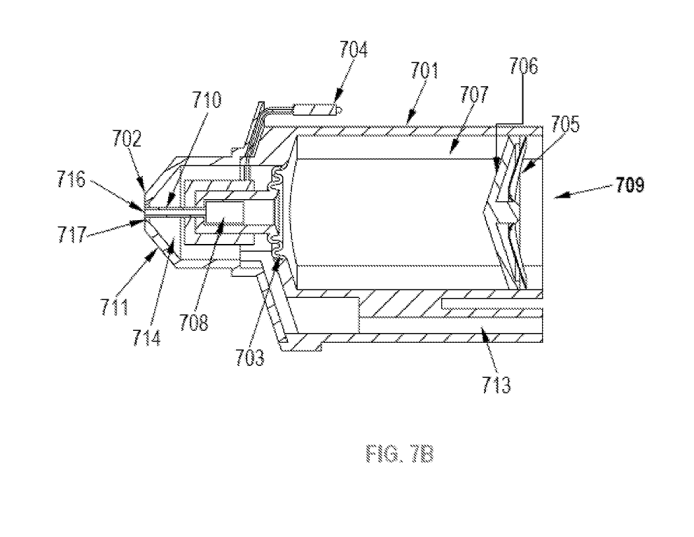

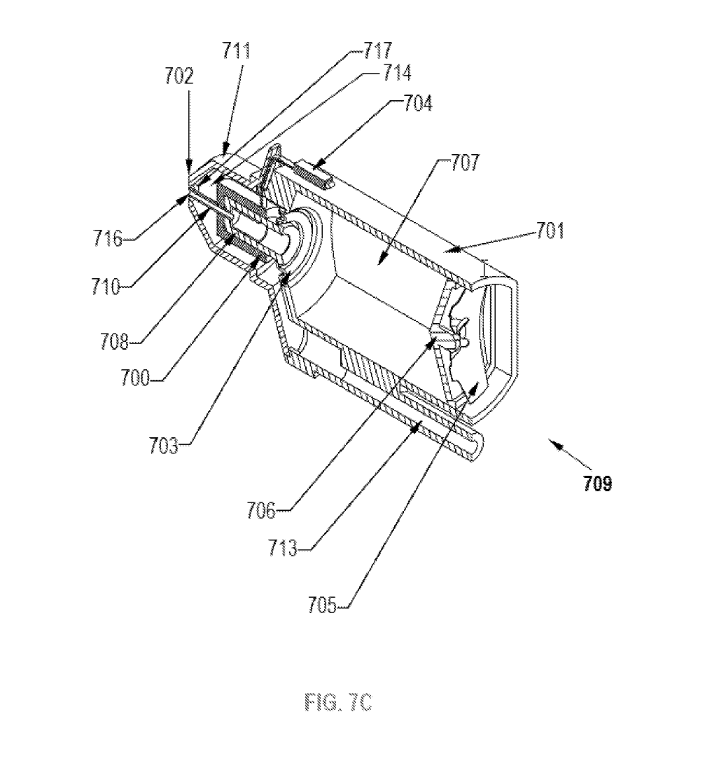

FIG. 7A shows a side view of an auto-propelled cartridge assembly 709. Inside a cartridge body 701, the rear end of a cartridge tank 707 holding fluid may consist of a steel breaking plate 705, which may make up the back wall of the cartridge tank 707, and which may advance a pushing piston 706 forward inside the cartridge tank 707. The front end of the cartridge tank 707 may lead into a steel front chamber 708, followed by a micro tube 710 exiting at a nozzle tip 702 through a fluid nozzle 716 surrounded by an air nozzle 717.

FIG. 7B shows a section normal to the centerline of an auto-propelled cartridge assembly 709. A one-way advancing steel breaking plate 705, acting as the back wall of a cartridge tank 707, may drive a pushing piston 706 forward inside a cartridge tank 707 enclosed in a cartridge body 701. Motion of the steel breaking plate 705 may be induced by vibration of a concentrically corrugated front wall 703 of the cartridge tank 707. A steel front chamber 708 and a micro tube 710 may be located inside a nozzle cover 711. Fluid may be dispensed at a nozzle tip 702 by a fluid nozzle 716. An electric connector 704 and an air coupling tube 713 may be located outside the cartridge tank 707 and may be connected to the front end of the cartridge 709. Air flow may be provided to an air nozzle 717 at the nozzle tip 702 via the air coupling tube 713 and a nozzle air cavity 714.

A perspective view of a section normal to the centerline of an auto-propelled cartridge assembly 709 is shown in FIG. 7C. Fluid may be pushed toward the front of a cartridge tank 707 inside a cartridge body 701 by a pushing piston 706 advanced forward by a steel breaking plate 705. When a front wall 703 with flexing concentric corrugated structure vibrates and flexes back and forth with the frequency of an ultrasonic transducer 700, a responding motion may be induced inside a cartridge tank 707 with a back wall made up of the one-way advancing steel breaking plate 705. Micro movements of the front wall 703 toward the rear end of the cartridge tank 707 may press on the fluid content inside the cartridge tank 707 and force it to exit forward, because the pushing piston 706 in the back of the cartridge tank 707 can only move forward due to the breaking action of the one-way advancing steel breaking plate 705. With each flexing of the corrugated membrane front wall 703 forward, all content inside the cartridge tank 707 may be pulled forward by vacuum forces, including the pushing piston 706 with steel breaking plate 705 attached to it.

Slowly advancing fluid may enter the front of the cartridge tank 707 and into a steel front chamber 708 surrounded by the tubular piezo-ceramic ultrasonic transducer 700. Fluid may be transferred from the steel front chamber 708 to the fluid nozzle 716 at the nozzle tip 702 via a micro tube 710 at the end of the steel front chamber 708. The tubular piezo-ceramic ultrasonic transducer 700 may transfer ultrasonic high frequency vibrations both to the front wall 703 and to the steel front chamber 708 and the micro tube 710 leading to a fluid nozzle 716, where ultrasonic energy may be applied to vaporize and disperse fluid exiting through the fluid nozzle 716. To guide and shape evaporated fluid into a desired shape and direction, low velocity air may be delivered to the front section of the cartridge via an air coupling tube 713 and a nozzle air cavity 714. Said compressed air may escape at the front end through an air nozzle 717 around the fluid nozzle 716. A physical or wireless electric connector 704 may provide an electrical connection, such as to a spraying device. The piezo-ceramic ultrasonic transducer 700, steel front chamber 708, micro tube 710 and nozzle air cavity 714 may be housed inside a nozzle cover 711 on the cartridge assembly 709.

Said auto-propelled means does not need an external force, such as a motor and a gearbox, to advance cartridge fluid content forward. However, in some instances, this design may be unable to control the amount of fluid advancement without changing the parameters of the ultrasonic frequency of said ultrasonic transducer 700.

Alternative designs of a breaking mechanism may be used. For example, the steel breaking plate 705 may not employ spring-loaded prongs; rather, a micro-structured surface of the cartridge tank such as micro-lamellae can provide selective movement in only one direction.

Further, in other embodiments of the invention, the inside of a cartridge may be made from a material other than steel, such as a material with greater elasticity combined with sufficient mechanical strength.

In describing the various embodiments of the invention, a fluid may include any liquid, semi-liquid and higher viscosity material, such as facial make-up and other types of cosmetic materials of a creamy or paste-like consistency. For example, the fluid may include a foundation, face powder, blush, bronzer, concealer, lip make-up, eye make-up, or other cosmetics, or sunscreen, skin lightener, tanning oil, lotion, skin-care cream, perfume, gels, deodorant, soap, or sanitizer.

Preferable embodiments of the invention include a removable cartridge. The cartridge can contain make-up or similar cosmetic compositions. Further, the cartridge can be disposed of once the contents are emptied. The ultrasonic transducer, being part of the cartridge, may be disposable. This may serve to avoid incapacitating the entire device as a result of limited lifetime of the ultrasonic transducer. By designing the present device in two parts (a permanent spraying device and a disposable cartridge) and by simplifying the operation of the disposable part, components needing frequent service and cleaning may be economically incorporated in the disposable part. The resulting design is less complicated, and technically and commercially more feasible than prior art designs.

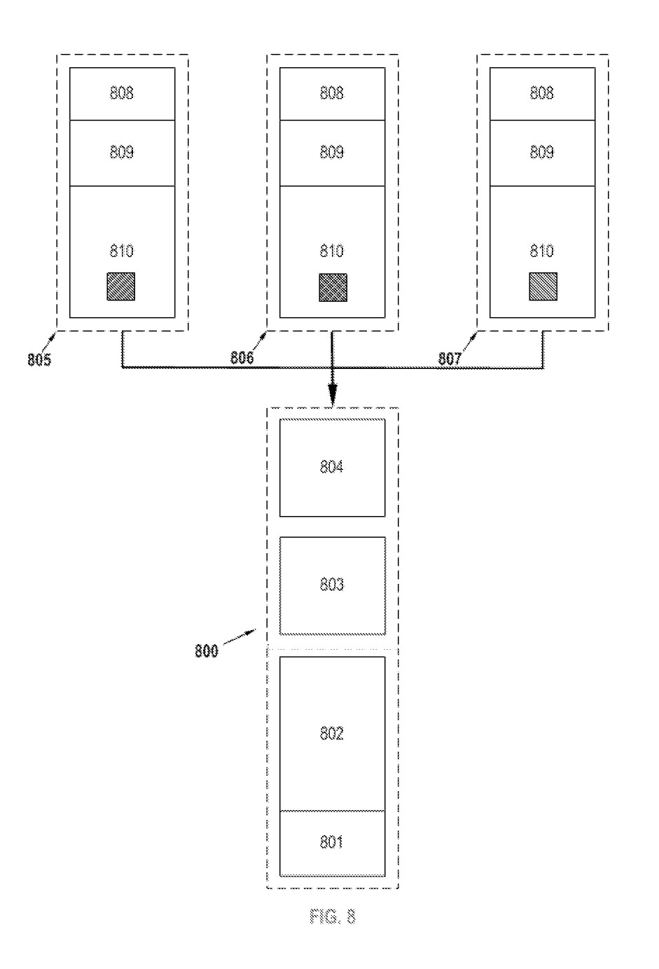

A conceptual view of an ultrasonic spraying device illustrating a forced propelling means in accordance with a gear-driven embodiment described herein is shown in FIG. 8. A permanent component assembly 800, referred to as a spraying device or a device handle, may constitute of an internal or external power source 802, an optional DC jack 801, a PCB controller 803 and a motor with gearbox 804, wherein the motor with gearbox may be substituted by other auxiliary components appropriate for a variation of said forced propelling means. The permanent assembly 800 may be docked with a plurality of interchangeable cartridges 805, 806, 807 or more, each consisting of a nozzle 808, a transducer 809 and a cartridge tank holding fluid 810. The permanent and removable parts of the apparatus are complementary.

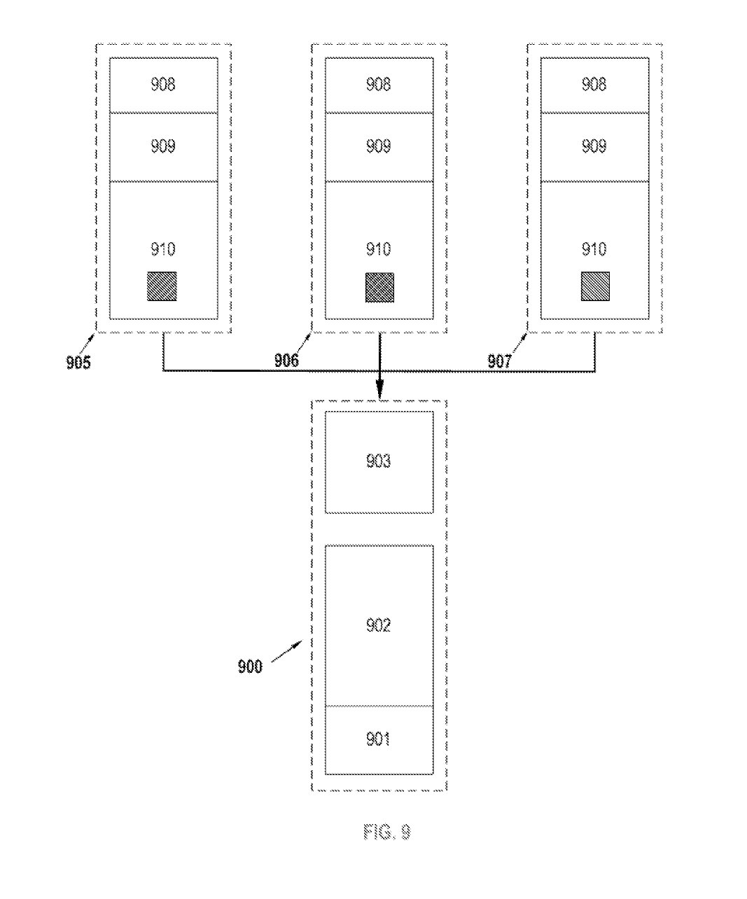

The previous schematic can be contrasted to an ultrasonic spraying device illustrating an auto-propelled means in accordance with an ultrasonic auto-propelled embodiment described herein, shown in FIG. 9. In this arrangement, a permanent component assembly 900, referred to as a spraying device or a device handle, may constitute of an internal or external power source 902, an optional DC jack 901 and a PCB controller 903. No motor with gearbox or other auxiliary components required to drive a forced propelling means are needed. The permanent assembly 900 may again be docked with a plurality of interchangeable cartridges 905, 906, 907 or more, each consisting of a nozzle 908, a transducer 909 and a cartridge tank holding fluid 910. This arrangement enables the complementary nature of the permanent and removable parts of the apparatus to be preserved, while at the same time, the complexity of the apparatus may be reduced.

In another aspect of the invention, methods of delivering said fluid are provided. By way of example in accordance with a preferable embodiment, when a user wants to apply a fluid, such as a make-up foundation, a cartridge containing the foundation may be inserted into a spraying device. The cartridge may be inserted by opening a front end snap-cover 104 or by other means of opening the device. Once the cartridge has been docked inside the spraying device, the ultrasonic spraying device may be turned on if provided with a power source, initiating spray delivery of the foundation. Directional air flow may be used to aid in focusing the spray onto a desired target, for example the user's face. The spray intensity can be adjusted with a control, one example being a slider button 103. This control may adjust the intensity of ultrasonic vibration of an ultrasonic transducer, such as a piezo-ceramic ultrasonic transducer 400, nozzle air flow or both in a combined or independent manner. The user may continue using the ultrasonic spraying device with no further action, or may make further adjustments. The fluid spray may be terminated or interrupted by turning the device off.

During operation of an ultrasonic spraying device, fluid contained inside a cartridge tank of a cartridge is advanced toward a nozzle at one end of the cartridge through various means, including a means utilizing ultrasonic energy for propelling the fluid. Near the nozzle, ultrasonic vibrational energy is transferred to the fluid to induce dispersion, vaporization or a combination thereof of said fluid. Ultrasonic vibrational energy may be provided by an ultrasonic transducer powered by a power source.

Advancing means of a fluid contained in a container, such as a cartridge tank inside a cartridge, may include forced propelling as well as auto-propelled means. Examples of forced propelling means may include a gear-driven means and an air pneumatic means; an example of an auto-propelled means may be an ultrasonic auto-propelled means.

If a forced propelling means, such as a gear-driven means, is utilized, additional components to drive cartridge fluid advancement may be provided, such as an electric motor that may be combined with a reduction gearbox.

Directional air flow may be used to aid spray precision and reach. Additional components necessary for providing said air flow may include an air pump and a motor to drive the air pump.

In accordance with a preferable embodiment, the present invention may be used as an airbrush, allowing make-up to be applied to the whole face, covering larger skin surfaces, as well as providing settings for high precision applications for lips and eyes.

A feature of the preferable embodiment is that the cartridge can be removed from the unit at any time and replaced by another similar cartridge containing a different make-up composition, or the same type of make-up composition but of different color. Each make-up composition is dispensed from a unique cartridge, with all wetted parts contained inside the cartridge. No cleaning or preparation between color or composition changes is required, thereby facilitating ease of use. Once the cartridge is removed, make-up does not escape from the cartridge due to its very high surface tension. A small plastic cap may be provided to seal and protect the nozzle tip.

Additional features and advantages of the present invention include the elimination of the need for pumping fluid between the cartridge tank and the nozzle through the use of said auto-propelled and forced propelling means. Further, the use of said auto-propelled means eliminates the need for mechanical propelling altogether. This arrangement enables dual utilization of ultrasonic vibration generated by said ultrasonic transducer as a means to spray fluid as well as to induce forward agitation of the fluid in the cartridge tank.

While preferable embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. An ultrasonic spraying device comprising:
a device body and nozzle covering;
a removable cartridge containing a fluid that is positioned with the device body, wherein the cartridge further includes:
a nozzle tip and front chamber positioned within at least a portion of the nozzle covering in communication with the cartridge; and
an ultrasonic transducer surrounding at least a portion of the front chamber for energizing the fluid which exits through the nozzle tip.

2. An ultrasonic spray cartridge assembly comprising:
a tank for holding a fluid;
a piston positioned within the tank for advancing the fluid within the tank to a front chamber; and
a tubular piezo-ceramic transducer surrounding at least a portion of the front chamber for energizing the fluid ejected from the cartridge assembly.

3. A handheld ultrasonic spraying device comprising:
a nozzle covering and body;
a power source; and
an ultrasonic spray cartridge assembly positioned within a portion of the nozzle covering comprising:
a tank for holding a fluid;
a pushing piston driven by the power source that is positioned within the tank for advancing the fluid within the tank to a front chamber; and
an ultrasonic transducer connected to the power source and surrounding at least a portion of the front chamber for energizing the fluid ejected from the cartridge assembly.
